(19) United States
(12) Patent Application Publication
(10) Pub. No.: US 2004/0121782 A1
(43) Pub. Date: Jun. 24, 2004

(54) Personal flotation device transceiver tracking system

(75) Inventor: Theodore Robert Tester, Portland, CT (US)

Correspondence Address: OFFSHORE DATA SERVICES LLC, 172 MIDDLE HADDAM ROAD, PORTLAND, CT, 06480, US

(73) Assignee: Offshore Data Services, LLC

(21) Appl. No.: 10/654,116

(22) Filed: Sep. 3, 2003

Related U.S. Application Data
(60) Provisional application No. 60/408,929, filed on Sep. 7, 2002.

(51) Int. Cl. H04Q 7/20

(52) U.S. Cl. 455/456.1; 455/456.3; 455/404.2; 455/427

(57) ABSTRACT

Tracking a personal flotation device transceiver is facilitated by an apparatus in which a personal flotation device transceiver sends a message identifying and locating the attached personal flotation device to a boat base station using a wireless broadband radio connection. The boat base station sends messages via data relay satellite to a network control center system; which, then sends emergency messages concerning the identities and locations of both the overboard personal flotation device transceiver and the boat base station to interested third parties using a broadband internet connection, a VHF radio transmitter and a telephone device. The network control center system also determines probable future position location information of the overboard personal flotation device transceiver; and, transmits this future position location information to interested third parties using standard telephone, VHF radio and internet connections.

### FIELD OF THE INVENTION

The invention relates to a method and apparatus for tracking a personal flotation device transceiver and a boat involved in a ‘man overboard’ incident that allows a boat base station located aboard the boat and a remote network control center to transmit emergency messages relating to the ‘man overboard’ incident to interested third parties such as the United States Coast Guard and various marine police units. More particularly, the invention comprises a wireless mobile virtual network operation which maintains communication links between a personal flotation device transceiver system, a boat base station system, a data relay satellite system, a network control center system and the Internet. Still more particularly, the system calculates probable future position location information for the personal flotation device transceiver involved in the ‘man overboard’ incident, and transmits this probable future position location information to the above referenced third parties in a timely manner. Additionally, the system allows the boat base station to transmit location information of the personal flotation device to a marine navigation plotter located aboard the boat where the boat base station is installed. The personal flotation device transceiver is powered by a 7.2 volt lithium ion battery with a methanol fuel cell as an optional auxiliary power source.

### BACKGROUND OF THE INVENTION

For boats with passengers or crew onboard, monitoring the locations of the passengers or crew is a challenging task. Because of the inherent danger of possible ‘man overboard’ incidents, a system is needed which actively monitors passenger and crew locations; and, also tracks the locations of the passengers or crew in the water if they fall overboard. In the past, such systems have been manual, relying on a person or persons on deck to keep watch over the passengers or crew and sound an alert if someone falls overboard. Currently, EPIRB (Emergency Positioning Radio Beacon) and PLB (Personal Locator Beacon) devices are available that transmit emergency ‘man overboard’ messages using a satellite network which is actively monitored by various governmental authorities. The required use of personal flotation devices by passengers and crew aboard boats while underway has been mandated by law in many states and other jurisdictions, to protect the safety of passengers and crew in the event of ‘man overboard’ incidents.

Presently, personal flotation devices are rated by type by the United States Coast Guard. The types range from one to five, based on various flotation criteria determined by United States Coast Guard Authorities. These personal flotation devices serve a single primary purpose, which is to keep the person wearing the device afloat if they are in the water.

A number of automated methods and devices for tracking personal flotation devices involved in ‘man overboard’ incidents have been disclosed. For instance, U.S. Pat. No. 6,545,606 to United States of America (U.S. Navy) describes an automated system for a boat capable of being alerted in a ‘man overboard’ incident and also tracking personal flotation devices using the narrowband RF (radio frequency) protocol; however, the PLB (personal location beacon) attached to the personal flotation device is only a water-activated transmitter. A system that relies on a transmitter device with its inherent battery dependency is limited in terms of reliability by the constraints of battery technology. The '606 patent is also restricted by the use of the narrowband RF (radio frequency) protocol, which has limited range and also specific line-of-sight requirements which are challenged in the marine environment where water surface conditions are often extreme. In addition, the '606 patent fails to offer additional modes of operation; but, instead relies simply on the single water-activated mode to cover all circumstances relating to marine emergencies. The '606 patent, therefore, fails to present a comprehensive solution to the ‘man overboard’ emergency required by the demanding conditions of the marine environment.

Because the present invention utilizes the broadband WI-FI™ (wireless fidelity) protocol using the unlicensed 2.4 Ghz radio spectrum, specific antenna systems are required to complete the emergency communication network for the present invention. U.S. patent application Ser. No. 2002159537 to Crilly and Biba (“the '537 patent application”) describes a ‘smart’ antenna system and apparatus which enables extended range WI-FI™ (wireless fidelity) connections to be established between ‘smart’ antenna(s) and a low power remote device up to a range of over 16 miles. The present invention utilizes a chained array of three ‘smart’ antennas described by the '537 patent application arranged in a triangular configuration on the boat to establish a 360 degree arc coverage area. This antenna configuration is linked to the boat base station located on the boat; and, creates a wireless broadband network connection between the remote transceiver attached to the personal flotation device and the boat base station located on the boat. In addition, an active Bluetooth™ network connection is maintained between the transceiver attached to the personal flotation device and the boat base station located on the boat. If this connection is broken, a ‘man overboard’ alert message is transmitted from the boat base station to the network control center which indicates that the person wearing the personal flotation device transceiver has fallen overboard. Because the transceiver attached to the personal flotation device also has GPS receiver functionality, the actual position fix of the ‘overboard’ personal flotation device can be transmitted back to the boat base station in real time. Also, the power level of the battery pack (including an auxiliary battery pack and an optional methanol fuel cell unit) is continually transmitted back to the boat base station to continually monitor reserve battery power for the entire system.

The present invention discloses an electronic interface with a marine navigation plotter device, which allows real-time tracking of the personal flotation device transceiver by the host boat during a monitored ‘man overboard’ incident. For instance, U.S. Pat. No. 4,939,661 to Barker, et al, describes an apparatus for a video marine navigation plotter with electronic charting capability. The '661 patent relies on either the Loran-C or GPS positioning systems to determine the location of the boat for the video display. The present invention maintains an active wireless data communication link between the boat base station device and the personal flotation device transceiver, allowing position coordinates for the personal flotation device (which are determined by the personal flotation device transceiver using a GPS receiver integrated with the PFD transceiver unit) to be immediately transmitted back to the boat base station, where they are forwarded as input data to the marine navigation plotter device for screen display purposes. This is a dual mode function. The ‘underway’ mode monitors the ‘man overboard’ incident; and, the ‘in port’ mode allows the boat base station to monitor other potential emergency situations incurred by the personal flotation device transceiver. Both modes allow the location of the personal flotation device transceiver(s) to be displayed on the marine navigation plotter video screen along with the host boat location.

An additional interface disclosed by the present invention is with a DSC (Digital Selective Calling) enabled VHF (Very High Frequency) marine radio. For instance, U.S. Pat. No. 6,567,004 describes a system and apparatus for automatically reporting an event to a remote location using the DSC (digital selective calling) protocol. The boat base station device of the present invention is electronically linked with the VHF/DSC radio device, and transmits a digitally synthesized voice distress message concerning the present locations of both the boat base station and the personal flotation device transceiver. The range of these radio transmissions is under 20 nautical miles; but, nearby boats equipped with VHF radios will be able to respond to the ‘man overboard’ incident in a timely manner. Presently, the United States Coast Guard is implementing the National Distress Response System Modernization Project (NDRSMP—also known as the ‘Rescue 21’ System). This emergency monitoring system relies on the DSC protocol to expand any marine distress call transmissions to both VHF channels 16 and 70. Using DSC enabled VHF marine radios, this ‘Rescue 21’ system provides enhanced emergency radio coverage up to 20 nautical miles from the coastline of the United States. The ‘Rescue 21’ system has coverage limitations; particularly for ‘man overboard’ or other emergency incidents occurring beyond the 20 nautical mile range limit of the United States coastline.

U.S. Pat. No. 6,580,384 to Institute for Information Industry (Taipei, TW) discloses a track prediction method in a combined radar and ADS (Automatic Dependent Surveillance) environment, and, provides air traffic control authorities with a means to determine future locations for aircraft in flight. This system utilizes three dimensional (i.e. latitude, longitude and altitude) tracking and is designed specifically for use with aircraft equipped with ADS systems. The use of the Kalman filter algorithm by the '384 patent is entirely dependent on the information generated by the ADS system aboard the tracked aircraft.

U.S. Pat. No. 6,564,146 to United States of America (US Navy) discloses a system for providing position information relative to a missile in flight tracking a flying target by correlating multiple satellite generated GPS position fix signals and event-related data. The '146 patent uses a three dimensional tracking system (latitude, longitude and altitude), and, utilizes GPS receivers located on the moving target, the tracking missile and a remote base station. The use of the Kalman filter algorithm by the '146 patent requires information generated by the GPS receivers located on the moving target, tracking missile and the remote base station.

What is desired is a personal flotation device tracking apparatus, which uniquely identifies the personal flotation device and also effectively monitors the device under all marine conditions. Further, it is necessary for the apparatus to have future position prediction capability for a personal flotation device transceiver involved in a ‘man overboard’ incident to expedite timely rescue and recovery of the personal flotation device transceiver by interested third parties. Because the primary goal of the present invention is to provide precise current and future location information for personal flotation device transceivers to a wide range of interested third parties, the event notification functions of the present invention utilize multiple automated communication methods to effectively report the ‘man overboard’ incident to as many different interested parties as possible. U.S. Pat. No. 6,580,903 to Infineon Technologies (“the '903 patent”) discloses a system for recording and playing back voice in digital mobile radio devices. The present invention has an electronic interface with a digital voice recording and playback system to allow emergency voice messages to be broadcast on multiple radio channels using a digital VHF radio linked to the boat base station aboard the boat where the ‘man overboard’ incident occurred.

Current vessel tracking systems utilize active tracking protocols such as radar sensors located in marine harbors to monitor vessel traffic, but this capability is insufficient because it is dependent on the limited deployment of the radar sensors used by the system. U.S. Pat. No. 6,249,241 to United States of America (U.S. Navy) (“the '241 patent”) describes a marine vessel tracking system for use in marine harbors. The '241 patent discloses an system using an active tracking protocol (i.e., the radar signals are generated as needed by the surveillance system).

What is desired then is to provide a tracking system using a ‘semi-passive tracking’ protocol. Active signals from GPS satellites are used (i.e. the GPS signals are always there; they can be used by anyone at any time).

It is further desired to provide a tracking system that will expedite the recovery process for personal flotation device transceivers that are involved in man overboard” or other emergency incidents regardless of geographical location.

It is still further desired to provide an apparatus for automatically establishing two-way communications between a personal flotation device and a boat and between said boat and a network control center facility when it has been determined that a ‘man overboard’ or other emergency incident has occurred.

It is yet still further desired to provide an apparatus that identifies the most probable future position location of a personal flotation device transceiver involved in a ‘man overboard’ incident; and, electronically transmits this future position location information to interested third parties to assist with their timely recovery efforts for the personal flotation device transceiver.

The invention and its particular features and advantages will become more apparent from the following detailed description considered with reference to the accompanying drawings.

### SUMMARY OF THE INVENTION

In accordance with the objects of the present invention, a personal flotation device communication apparatus is providing for automatically communicating with a boat base station system installed aboard the boat and a remote network control center, the apparatus comprising: a personal flotation device transceiver system; a personal flotation device transceiver system database accessible by said personal flotation device transceiver system; a boat base station system; a boat base station system database accessible by said boat base station system; a communication means for connecting said personal flotation device transceiver system to said boat base station system; an algorithm transmitted by said onboard personal flotation device transceiver system to said boat base station system; an algorithm transmitted by said overboard personal flotation device transceiver system to said boat base station system; a network control center system; a communication means for connecting said boat base station system to said network control center system; an algorithm transmitted by said boat base station system to said network control center system and a statistical method used by said network control center system to determine probable future position location information for said overboard personal flotation device transceiver system.

In a further embodiment of the present invention, a digitally synthesized voice communication apparatus for automatically communicating with remote VHF (very high frequency) radio receivers and remote CB (citizens band) radio receivers is provided, the apparatus comprising: a boat base station system; a boat base station system database accessible by said boat base station system; a personal flotation device transceiver system; a personal flotation device transceiver system database accessible by said personal flotation device transceiver system, a digital voice synthesizer; an identification means for identifying the boat where said boat base station system is installed; an identification means for identifying said personal flotation device transceiver system; a means for determining the position location of the personal flotation device transceiver and a means for determining the position location of the boat base station system.

The invention and its particular features and advantages will become more apparent from the following detailed description considered with reference to the accompanying drawings.

### BRIEF DESCRIPTION OF THE DRAWINGS

FIG. 1 is a block diagram of an advantageous embodiment of the present invention, an interconnection of a personal flotation device transceiver system, a boat base station system and a network control center system.

FIG. 2 is a block diagram illustrating the system of FIG. 1 in greater detail showing the communication connection between the boat base station system and the personal flotation device transceiver system.

FIG. 3 is an illustration of a personal flotation device transceiver system unit in one advantageous embodiment.

FIG. 4 is an illustration of a boat base station system unit in one advantageous embodiment.

FIG. 5 is a block diagram illustrating the system process flow relating to the modules of the boat base station system unit illustrated in FIG. 4.

FIG. 6 is a block diagram illustrating the algorithm corresponding to FIG. 1 in another advantageous embodiment.

FIG. 7 is a block diagram illustrating the algorithm corresponding to FIG. 1 in yet another advantageous embodiment.

### DETAILED DESCRIPTION OF THE DRAWINGS

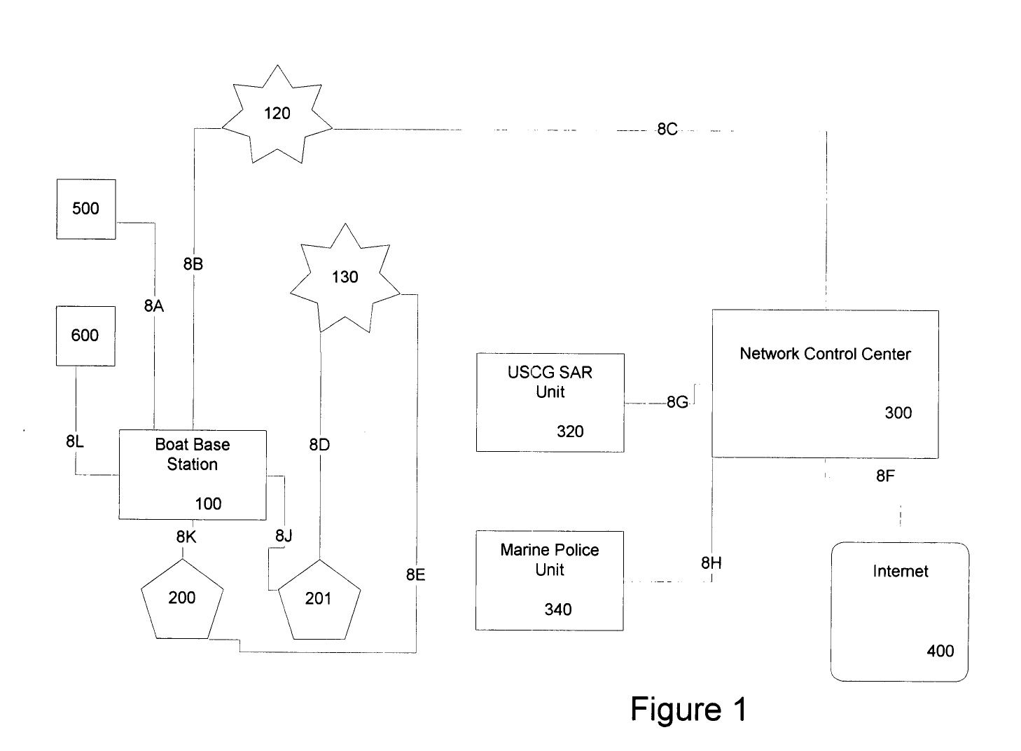

One advantageous embodiment of the present invention is illustrated in FIG. 1. The personal flotation device tracking apparatus 10 includes a boat base station system 100, a personal flotation device system 200, a nth personal flotation device system 201 and a network control center system 300. The boat base station system 100, installed aboard a boat, communicates with a data relay satellite 120 via a wireless data connection 8B. The data relay satellite 120 communicates with a network control center 300 via a wireless data connection 8C. The wireless data connection 8B, the data relay satellite 120 and the wireless data connection 8C constitute a Mobile Virtual Network (MVN), a platform which allows a service to rent commonly available wireless broadband, and add value, in this case a real-time personal flotation device tracking and monitoring service, for its customers. The boat base station system 100 communicates with a personal flotation device system 200 via a wireless broadband Bluetooth™ bi-directional connection 8K. The boat base station system 100 also communicates with a personal flotation device system 201 via a wireless extended range broadband WI-FI™ bi-directional connection 8J.

Each boat base station system, including the boat base station system 100, can track one or more personal flotation device systems. The boat base station system 100 may determine that the personal flotation device system 200 is within the range of still being aboard the boat where the boat base station system 100 is installed by monitoring the active wireless broadband Bluetooth™ bi-directional connection 8K. The boat base station system 100 may also determine that the personal flotation device system 201 is beyond the range of still being aboard the boat where the boat base station system 100 is located by detecting the inactive wireless broadband Bluetooth™ bi-directional connection 8K. The wireless GPS satellite connection 8E is inactive as long as the wireless broadband Bluetooth™ bi-directional connection 8K is active, because GPS signals don't need to be processed by the personal flotation device system 200 unless there is a ‘man overboard’ incident that results in the deactivation of the wireless broadband Bluetooth™ bi-directional connection 8K between the boat base station system 100 and the personal flotation device system 200. The boat base station 100 also transmits digitally synthesized emergency voice messages to a remote marine VHF radio 500 via a VHF radio signal 8A during a monitored ‘man overboard’ incident. The boat base station 100 additionally transmits digitally synthesized emergency voice messages to a remote citizens band radio 600 via a citizens band radio signal 8L during a monitored ‘man overboard’ incident.

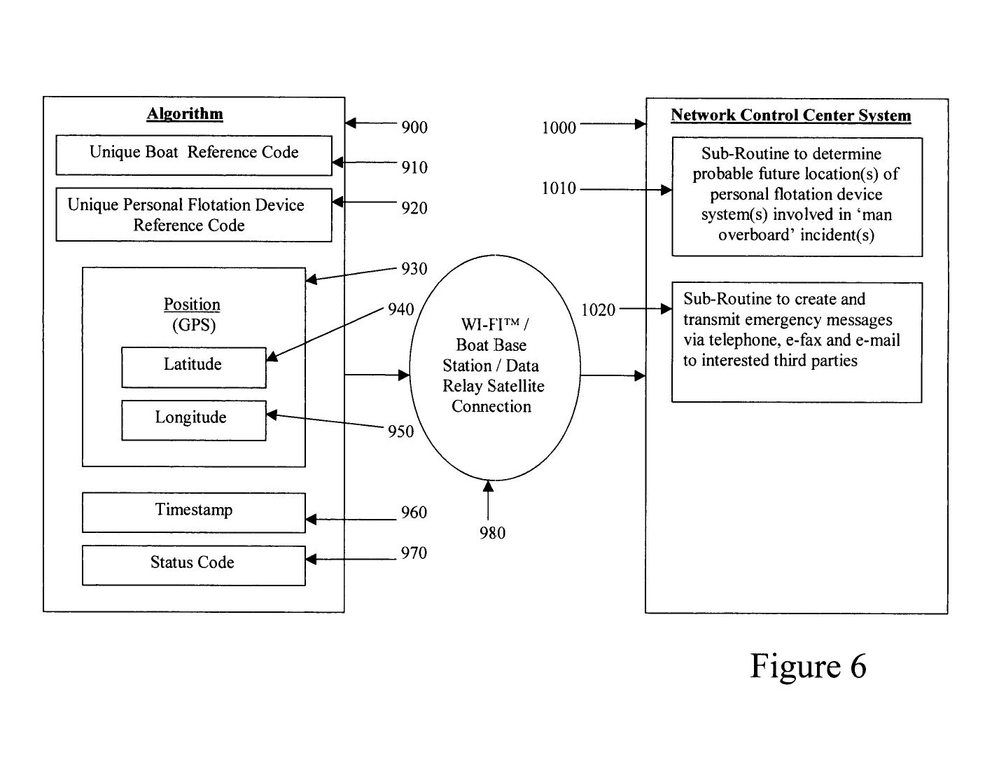

Still referring to the embodiment shown in FIG. 1, the network control center system 300 communicates with the relay satellite 120 via a wireless bi-directional data connection 8C. The network control center system 300 also communicates with the United States Coast Guard Unit 320 via a standard telephone connection 8G. In addition, the network control center system 300 communicates with the local marine police unit 340 via a standard telephone connection 8H. The network control center system 300 is electronically connected with the Internet 400 via bi-directional broadband connection 8F. This bi-directional broadband connection 8F enables the network control center system 300 to transmit emergency e-mail and IM (instant message) notifications concerning the ‘man overboard’ incident monitored by the personal flotation device system 200 to interested third parties. The network control center system 300 identifies the specific personal flotation device with the personal flotation device system 201 using the unique PFD (personal flotation device) reference code defined by the algorithm illustrated in FIG. 6. This is the critical ‘man overboard’ situation where the personal flotation device system 200 has deactivated the wireless broadband Bluetooth™ bi-directional connection 8K and has subsequently become the personal flotation device system 201. It is the transformation of the personal flotation device system 200 from an ‘on board’ situation into the personal flotation device system 201 involved in a ‘man overboard’ incident. The personal flotation device system 201 has an active wireless GPS satellite connection 8D to GPS satellite 130, which allows the current position location of the personal flotation device system 201 to be transmitted by the personal flotation device system 201 to the boat base station system 100 via the wireless extended range broadband WI-FI™ bi-directional connection 8J. The current position location information of personal flotation device system 201 is then transmitted by the boat base station system 100 to the network control center system 300 via the wireless bi-directional data transfer connection 8B, the data relay satellite 120 and the wireless bi-directional data transfer connection 8C. The network control center system 300 then transmits the current and future position location information of personal flotation device system 201 to the United States Coast Guard unit 320 via a standard telephone connection 8G. The network control center system 300 also transmits the current and future position location information of personal flotation device system 201 to the local marine police unit 340 via a standard telephone connection 8H. Additionally, the network control center system 300 transmits the current and future position location information of the personal flotation device system 201 to the Internet 400 via the bi-directional broadband connection 8F. Also, the network control center system 300 transmits the future position location information of the personal flotation device system 201 to the boat base station system 100 via the via the wireless bi-directional data transfer connection 8C, the data relay satellite 120 and the wireless bi-directional data transfer connection 8B.

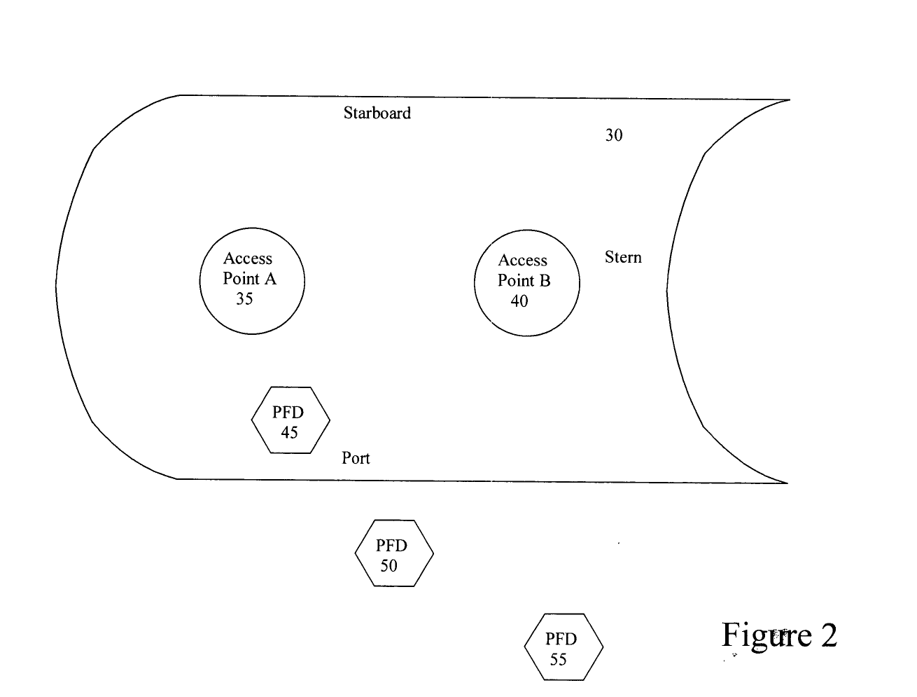

FIG. 2 along with FIG. 1 shows an overhead view of a boat equipped with two access points. Access point A 35 is located in the bow section of the boat, while access point B 40 is located in the aft section of boat 30. For the purposes of illustration, boat 30's beam is 36 feet, boat 30's length is 70 feet and access points A 35 and B40 each have a 35 foot diameter circular coverage area. Other high-gain antenna configurations (i.e. access points) can expand the circular coverage area of a single access point up to a up to a 600 foot diameter. Both of these overlapping circular coverage areas constitute a wireless personal area network (WPAN) in which the personal flotation device (PFD) transceiver system 45 maintains an active broadband Bluetooth™ bi-directional connection with the boat base station system 100 via access point A 35 and access point B 40. The Bluetooth™ broadband communication protocol uses the 2.4 GHz ISM (Industrial, Scientific, Medical) radio spectrum for signal transmission. The Bluetooth™ protocol is not line-of-sight dependent. For purposes of illustration, FIG. 2 shows the relative locations of the same PFD transceiver system over a elapsed time span of 5 minutes, represented by PFD transceiver systems 45, 50 and 55. The PFD transceiver system 45 is on board the boat 30 at a time of 14:15:00 (military time), located on the port bow section of the boat 30. At 14:17:15 (military time), the location of the PFD transceiver system 50 is overboard, off the port bow of the boat 30. The PFD transceiver system 50 still maintains an active broadband Bluetooth™ bi-directional connection with the boat base station 100 system via access point A 35 and access point B 40. At 14:20:00 (military time), the location of the PFD transceiver system is beyond the 35 foot circular coverage areas of access point A 35 and access point B 40. The PFD transceiver system 55 fails to maintain an active broadband Bluetooth™ bi-directional connection with the boat base station system 100 via access point A 35 or access point B 40, and this condition results in the generation of an electronic ‘man overboard’ alert by the boat base station system 100. This ‘man overboard’ alert initiates the automated ‘man overboard’ PFD transceiver system 55 tracking process, which is a primary function of the present invention.

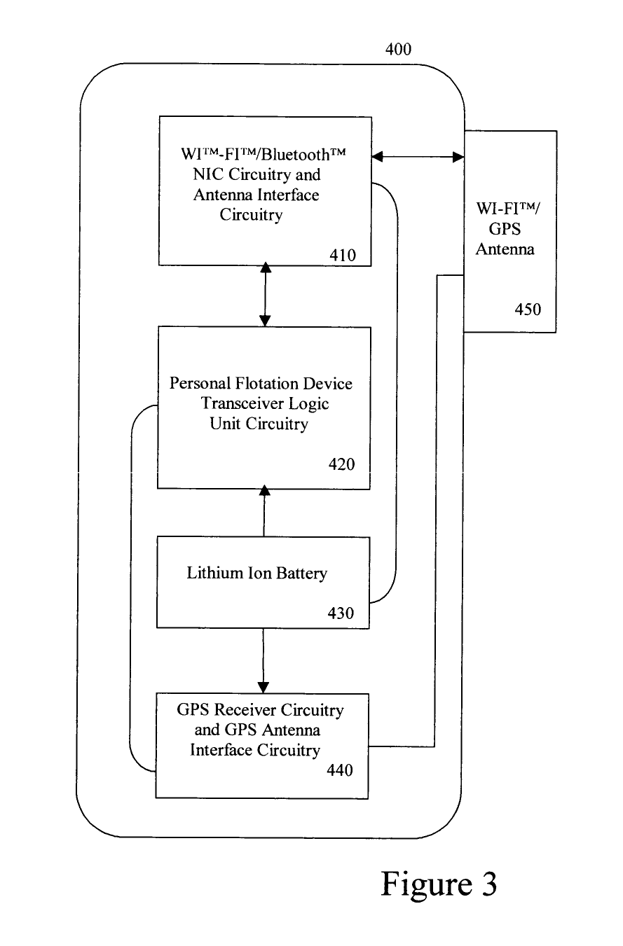

Referring now to FIG. 3 along with FIG. 1 for a more detailed illustration of the system, FIG. 3 is an illustration of a PFD transceiver system unit shown from a top view. The PFD transceiver system unit 400 is enclosed in a waterproof polycarbonate case. The WI-FI™ (Wireless Fidelity)/Bluetooth™ NIC (Network Interface Card) and antenna interface circuitry are contained in module 410. An example of the WI-FI™/Bluetooth™ NIC contained in module 410 is the Blue802™ mini-PCI card produced by Silicon Wave, Inc. of San Diego, Calif. Intersil Corp. of Milpitas, Calif. is another manufacturer of similar circuitry. A major consideration for the design of the PFD transceiver system unit 400 is overall size; therefore, the use of the dual-mode transmission circuitry (Bluetooth™ and WI-FI™) is warranted. The use of a small, low profile Bluetooth™ chip antenna is indicated for module 410. An example of this type of Bluetooth™ antenna is the ANCM12G455AA075 series Bluetooth™ chip antenna manufactured by Murata Manufacturing Co., Ltd. of Kyoto, Japan. For the PFD transceiver logic unit 420, the preferred microcontroller is the Motorola™ 68HC908AS60; but, other equivalent microcontrollers made by other manufacturers are also usable. Additionally, for the PFD transceiver logic unit 420, programmable ROM (Read Only Memory) is used to permanently retain the PFD transceiver system 400 software requirements. RAM (Random Access Memory) is used to store location data, calendar data and other operands. A battery pack unit 430 is illustrated as the primary power source for the PFD transceiver system 400. A lithium ion rechargeable battery pack, such as the Panasonic™ H601 manufactured by the Matsushita Electric Industrial Co. Ltd. of Osaka, Japan, is an example of the battery pack unit 430. Additional power source options for the PFD transceiver system 400 include a auxiliary battery pack and a auxiliary methanol fuel cell, such as the DMFC (Direct Methanol Fuel Cell) manufactured by Toshiba Corp. of Tokyo, Japan. Additionally, the power reserve of the battery pack unit 430 is continually monitored by the PFD transceiver logic unit 420. If the power reserve drops below a defined acceptable performance level, an electronic low-power warning message is transmitted to the boat base station station system 100 by the PFD transceiver unit 400. This battery power performance monitoring function is critical for the operation of the entire PFD transceiver tracking system described by the present invention.

For the GPS receiver module 440, the preferred circuitry is the PointCharger SE4100 integrated receiver IC (Integrated Circuit) manufactured by SiGe Semiconductor Corp. of Ottawa, Ontario, Canada. This circuitry has a very low current draw (10 mA from a 2.7 v supply); and, a very small overall size (4 mm×4 mm). Since power consumption is a critical issue for the PFD transceiver unit 400, it is vital to have low-power circuitry to extend the effective operational life of the PFD transceiver system during a ‘man overboard’ incident. Other GPS chipsets made by other manufacturers are also usable.

For the self-deploying antenna module 450, the preferred configuration is the external wireless device antenna model WXC1850 manufactured by Centurion Wireless Technologies, Inc. of Lincoln, Nebr. coupled with the Raven GPS Patch antenna manufactured by Raven Industries of Sioux Falls, S. Dak. Additional antenna components made by various manufacturers are available and are also usable. The external dimensions of the PFD transceiver unit 400 are 7⅜ inches in length, 3⅝ inches in width and 1 inch in height. The external dimensions of the self-deploying antenna module 450 are 1⅞ inches in height, 7/8 inch in width and 1 inch in depth. The self-deploying antenna module 450 is attached to the main body of the PFD transceiver unit 400 along the upper right side of the PFD transceiver unit 400, as seen from a top view. The PFD transceiver unit 400 is designed to be attached to a PFD (personal flotation device) which has been fitted with a secure vertically oriented closeable pocket located in an upper area of the PFD. The secure pocket may be above the left upper chest area, right upper chest area or behind the lower neck area of the individual wearing the PFD. This placement of the PFD transceiver unit 400 on the PFD is required because the individual wearing the PFD in a ‘man overboard’ situation will displace a great amount of water. This displacement will vary depending on the salinity, or lack thereof, of the body of water where the ‘man overboard’ incident occurred. The goal of this placement of the PFD transceiver unit 400 on the PFD is to keep the self-deploying antenna module 450 as far above the water surface as possible, to enable consistent radio signal transmission between the GPS satellite network, the PFD transceiver unit 400 and the boat base station system 100 located on the boat 30. It is important to note that the PFD transceiver unit 400 is a automated device; because in many MOB (‘man overboard’) situations the MOB victim is incapacitated, and therefore unable to manually activate the device.

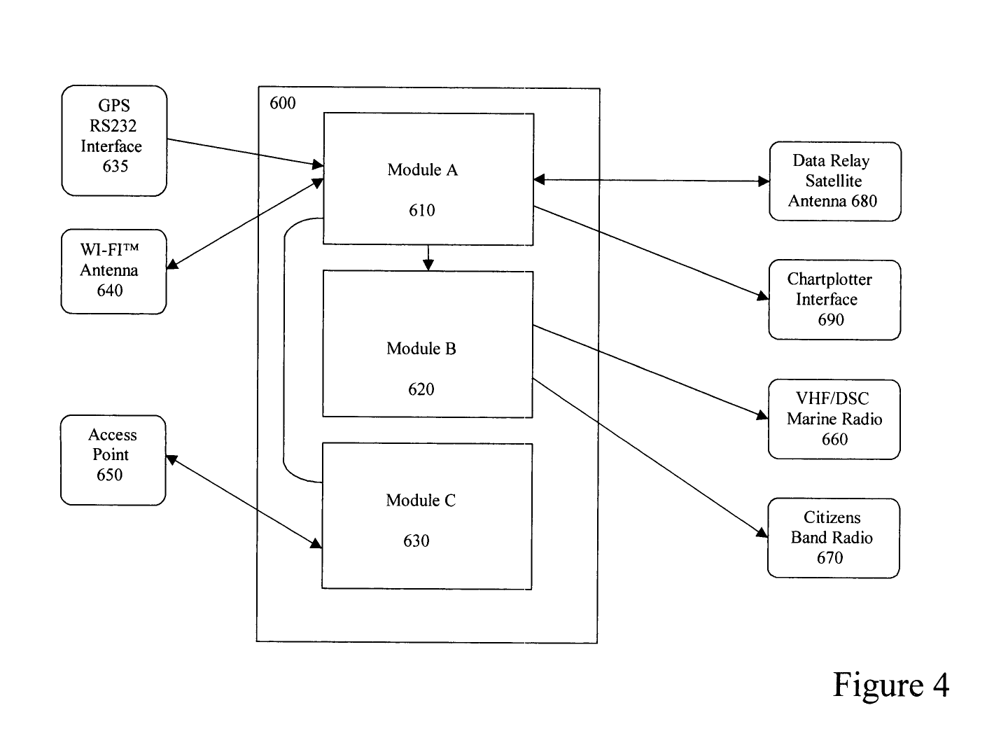

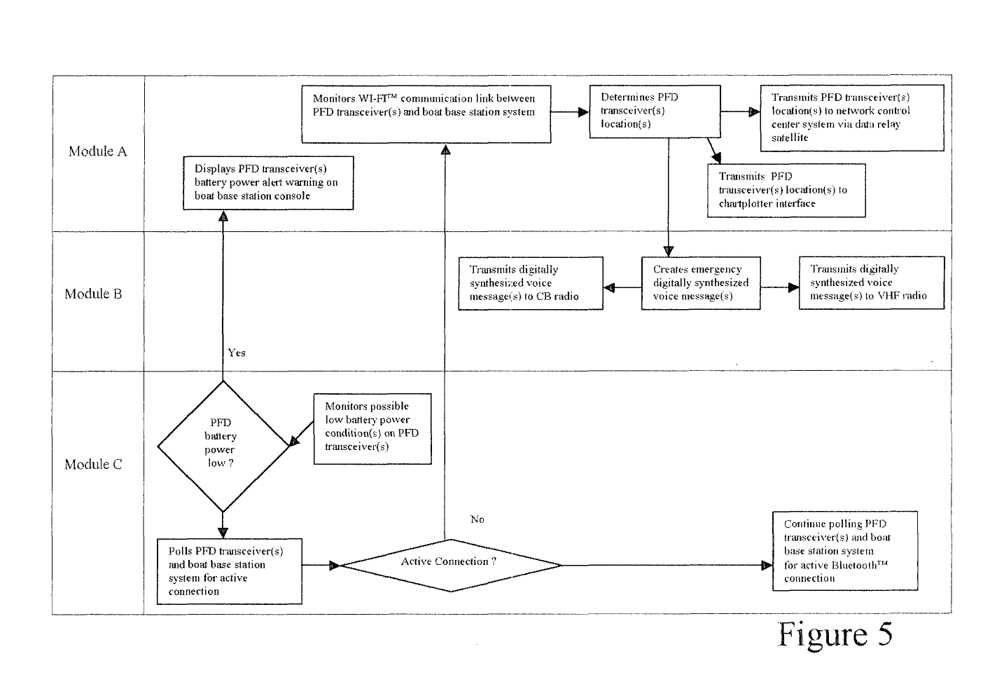

Referring now to FIG. 4 along with FIG. 2, FIG. 3 and FIG. 5, for a more detailed illustration of the PFD tracking system described by the present invention, FIG. 4 is an top view illustration of the boat base station system unit 600. The boat base station system unit 600 is enclosed in a waterproof, polycarbonate case. The outside dimensions of the boat base station system unit 600 are 8¾ inches in width, 10¼ inches in length and 2 inches in height.

Module A 610 of the boat base station system unit 600 contains circuitry which processes wireless data transmissions between the boat base station system unit 600 on boat 30 and the PFD transceiver system 400. For module A 610, the preferred microprocessor is the Intel® PXA250 processor manufactured by Intel Corp. of Santa Clara, Calif. Other microprocessors made by other manufacturers are also usable. Module A 610 is connected to an extended range WI-FI™ antenna 640 which is mounted on the exterior of boat 30 where the boat base station system unit 600 is installed. For the extended range WI-FI™ antenna 640, the preferred antenna is the model 100-00950B outdoor 2.4 GHz WI-FI™ switch manufactured by Vivato, Inc. of San Francisco, Calif. Other antennas made by other manufacturers are also usable. In order to achieve a full 360 degree arc coverage area, three of these switches are assembled and linked in a equilateral triangular configuration. The extended range of this outdoor antenna configuration is 7.2 km at 1 Mbps, 6 km at 2 Mbps, 5.1 km at 5.5 Mbps and 4.2 km at 11 Mbps. The extended range WI-FI™ antenna 640 is mounted externally on boat 30 as high as possible to maximize the effective range between the boat base station system unit 600 on boat 30 and the ‘man overboard’ PFD transceiver 400. Module A 610 also has a GPS receiver/interface used the determine the location of boat 30. This interface consists of a RS232 data download interface 635 which is connected to a remote GPS receiver also installed on the boat. The above mentioned microprocessor of Module A 610 receives the GPS position data download for the location of boat 30 from this RS232 interface and forwards the position location information to the Data Relay Satellite Antenna 680. The preferred remote GPS receiver is the Magellan FX324 MAP/MAP COLOR model manufactured by Thales Navigation Corporation of Santa Clara, Calif. Other GPS receivers made by other manufacturers are also usable. The preferred antenna for the remote GPS receiver is the Meridian Color Antenna manufactured by by Thales Navigation Corporation of Santa Clara, Calif. Other GPS antennas made by other manufacturers are also usable.

Module B 620 of the boat base station system unit 600 contains circuitry which creates custom synthesized digital voice messages for transmission via the VHF/DSC marine radio 660 and the CB (citizens band) radio 670 located aboard boat 30 where the boat base station unit 600 in installed. For Module B 620, the preferred circuitry is the TextSpeak™ module TTS-03 manufactured by Digital Acoustics Corporation of Westport, Conn. Other synthesized digital voice chipsets made by other manufacturers are also usable.

For the Bluetooth™ Access Point 650 of the boat base station system 600, the preferred access point is the AirConnect® 11 Mbps wireless LAN model number 3CRWE777A manufactured by 3COM Corp. of Santa Clara, Calif. Other access points made by other manufacturers are also usable.

For the wireless satellite data relay antenna 680 of the boat base station system 600, the preferred antenna system is the TracNet™ 2.0 antenna system and the TracNet™ 2.0 mobile internet router/server manufactured by KVH Industries, Inc. of Middletown, R.I. Other antenna systems made by other manufacturers are also usable.

For the VHF/DSC radio 660 of the boat base station system 600, the preferred VHF/DSC radio is the VHF/DSC model RS8400 (Serial RS232 interface standard) manufactured by Simrad, Inc. of Kongsberg, Norway. Other VHF/DSC radios made by other manufacturers are also usable. In reference to the operation of the boat base station system 600, the input to the VHF/DSC radio 660 is the output of the module B 620, a simple electronic rotary switch is installed between the standard radio microphone and the actual radio body of the VHF/DSC radio 660. The preferred rotary switch is the rotary switch model 275-1386 manufactured by Radio Shack Corporation of Fort Worth, Tex. Other rotary switches made by other manufacturers are also usable.

For the CB (Citizens Band) radio 670 of the boat base station system 600, the preferred CB radio is the model PRO0510XL made by Uniden Corporation of Forth Worth, Tex. Other CB radios made by other manufacturers are also usable. In reference to the operation of the boat base station system 600, the electronic input to the CB radio 670 is the electronic output of the module B 620 using the RS-232 standard interface protocol. A simple rotary switch is installed between the standard radio microphone and the actual radio body of the CB radio 670. The preferred rotary switch is the Rotary switch model 275-1386 manufactured by Radio Shack Corporation of Fort Worth, Tex. Other rotary switches made by other manufacturers are also usable.

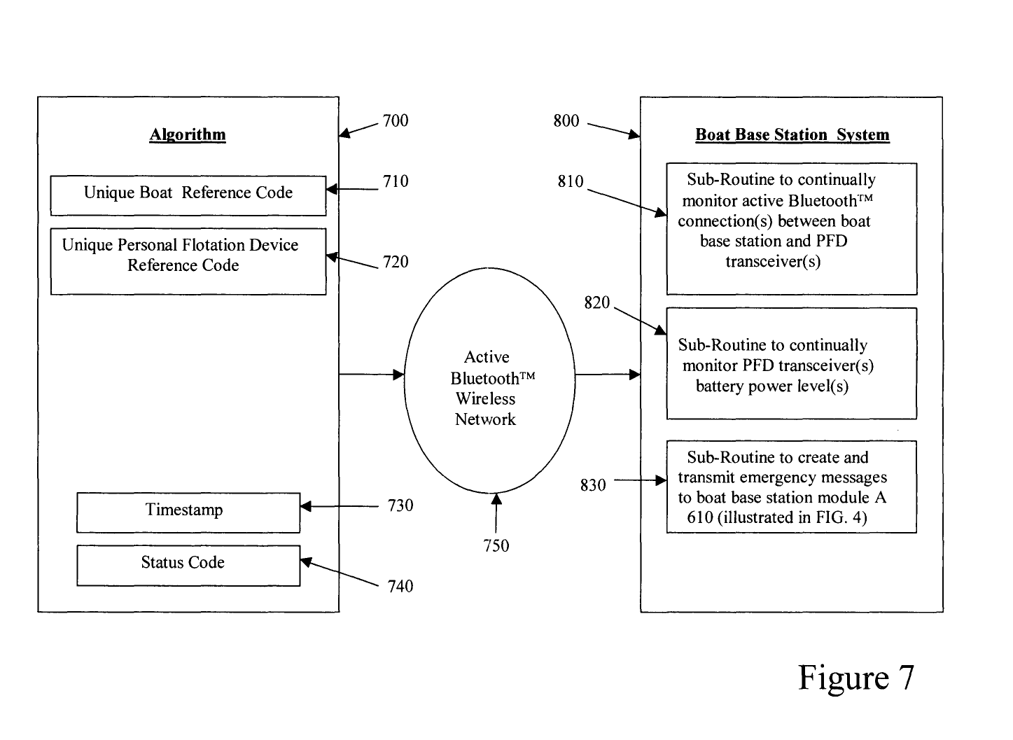

Referring now to FIG. 4 along with FIG. 2, FIG. 6 and FIG. 7, Module C 630 of the boat base station system 600 contains circuitry which monitors the active Bluetooth™ bi-directional connection between the boat base station 600 and PFD transceiver 45. The circuitry of Module C 630 is programmed to continually poll for an active Bluetooth™ bi-directional connection between module C 630 and PFD transceiver 45. The circuitry of Module C 630 is additionally programmed to send an electronic alarm signal to module A 610 if the active Bluetooth™ bi-directional connection is dropped. The circuitry of Module C 630 is also programmed to continually monitor the battery power level of the PFD transceiver 45. If a low battery power condition is detected for the monitored PFD transceiver 45, Module C 630 sends an electronic power warning message identifying the specific PFD transceiver 45 with the low battery power condition to Module A 610 so that the situation can be corrected before there is a system power failure. Algorithm 700 is used by Module C 630 to identify the specific PFD transceiver 45 with the low battery power condition. The preferred circuitry for Module C 630 is the HC508 model 68HC908AS60 manufactured by Motorola, Inc. of Schaumberg, Ill. Other circuitry made by other manufacturers is also usable.

As stated above, it is possible to use a PFD transceiver signal without position location information. This situation occurs when the PFD transceiver is on board boat 30 and maintains an active Bluetooth™ connection with boat base station 600. Algorithm 700 illustrates this PFD transceiver signal, and comprises unique boat reference code 710, unique PFD reference code 720 timestamp 730 and status code 740. Using algorithm 700, the boat base station system 800 actively monitors the status code 740 of a PFD transceiver system which is identified by the unique PFD reference code 720. If an active Bluetooth™ connection is dropped between PFD transceiver 45 and boat base station system 800, the connection monitoring sub-routine 810 will detect this condition. At this point, the boat base station system 800 will initiate the PFD transceiver system location tracking procedure(s) which are used by algorithm 900. If a low battery power condition(s) occurs on the above mentioned PFD transceiver 45, the status code 740 of PFD transceiver system 45 will be updated by the PFD transceiver 45's microprocessor to reflect the PFD transceiver s low battery power condition. Since a low battery power condition for PFD transceiver 45 is a critical system fault, it is essential for the boat base station system 800 to have constant PFD transceiver system battery power monitoring functionality.

Considering now both FIG. 1 and FIG. 7, the algorithm 700 enables the boat base station system 800 to actively monitor a specific PFD transceiver 200 by identifying the specific PFD transceiver 200 with a unique boat reference code 710. In this embodiment the algorithm consists of 4 elements including unique boat reference code 710, unique PFD reference code 720, timestamp 730 and status code 740. The unique boat reference code 710 may be the hull number of the boat where the boat base station 100 is installed or any other reference number. The unique PFD reference code 720 may be a sequential number or any other reference number. The time stamp 730 is used for notification purposes. The status code 740 is used for the purpose of of monitoring the power level of the PFD transceiver battery. If the battery power monitoring sub-routine 820 detects a low battery power condition on a PFD transceiver 200 or PFD transceiver 201, the emergency messaging sub-routine 830 transmits a low power alert message to the network control center 300 via data relay satellite 120. The low power alert message is also displayed locally using a blinking light and a audible siren attached to the boat base station system 800. There can only be one unique boat reference code 710 for the boat base station system 800, which conforms to the referential integrity rule commonly used for computer relational database system architecture. There can be multiple unique PFD reference code(s) 720 for each unique boat reference code 710; but, there must be at least one unique PFD reference code 720 for each unique boat reference code 710. The use of the algorithm 700 by the boat base station system 800 enables precise monitoring of PFD transceiver systems on vessels of any size, including commercial cruise ships and military vessels which could have large numbers of active PFD transceivers 200 onboard and linked to a specific boat base station system 100.

Referring now to FIG. 6 as well as FIG. 1, the algorithm 900 allows the boat base station 100 to send individualized messages concerning the current position location of the PFD transceiver 201 to the network control center 300 via wireless data transfer connection 8B, data relay satellite 120 and wireless data transfer connection 8C. Algorithm 900 illustrates this individualized PFD transceiver 201 location message, and comprises unique boat reference code 910, unique PFD reference code 920; position 930 including latitude 940 and longitude 950; timestamp 960 and status code 970. Upon receiving this algorithm 900, the sub-routine 1010 calculates future probable position location information for the PFD transceiver 201. Module 1020 sends this information to interested parties such as the USCG unit 320, the marine police unit 340, the Internet 400; and also back to the boat base station 100. Because the calculation of the future probable position location information for the PFD transceiver 201 involves complex statistical computations using the ‘Kalman Filter’ algorithm, the sub-routine 1010 is responsible for this function. The unique boat reference code 910 may be the hull number of the boat where the boat base station 100 is installed or any other unique reference number. The unique PFD reference code 920 may be a sequence number or any other unique reference number. The position fix 930 comprises the latitude 940 and the longitude 950 of the ‘man overboard’ PFD transceiver, although the specific format of the position fix 930 may vary. The time stamp 960 is used for instance, by module 1010 for future probable location calculations and also for notification purposes. The status code 970 is used for monitoring purposes.

The disclosed embodiments of the present invention may also incorporate features known to those skilled in the art. For example, a user may desire to integrate one-touch emergency buttons into the system. The one-touch emergency buttons can be used to contact any number of emergency service personnel such as the police, firefighters, Coast Guard personnel, or towing/repair service, and button activation could send messages using the previously described third party messaging functionality. Additionally, a one-touch emergency button could be used for low-level emergency messaging between the PFD transceiver and the boat base station, such as the situation where an individual wearing a PFD equipped with a PFD transceiver is piloting a motorized dinghy that runs out of gas or otherwise breaks down while underway.

Although the invention has been described in reference to a particular arrangement of parts, features and the like, these are not intended to exhaust all possible arrangements or features, and indeed many other modifications and variations will be ascertainable to those of skill in the art.

What I claim as my invention is:

1. A personal flotation device communication apparatus for automatically communicating with a boat base station and a network control center the apparatus comprising:
a personal flotation device transceiver system;
a communication means for connecting said personal flotation device transceiver system to said boat base station system;
a boat base station system;
a boat base station system database accessible by said boat base station system;
a network control center system;
a network control center system database accessible by said network control center system;
a communication means for connecting said boat base station system to said network control center system;
a tertiary algorithm transmitted by said boat base station system to said network control center system, the tertiary algorithm including:
a unique identification code for identifying the personal flotation device transceiver;
a location of the personal flotation device transceiver;
a unique identification code for identifying the boat;
a location of the boat,
a timestamp; and
a status code;
a secondary algorithm transmitted by said personal flotation device system to said boat base station system, the secondary algorithm including:
a unique identification code for identifying the boat;
a unique identification code for identifying the personal flotation device transceiver;
a location of the personal flotation device transceiver;
a timestamp; and
a status code; and,
a primary algorithm transmitted by said personal flotation device system to said boat base station system the primary algorithm including:
a unique identification code for identifying the boat;
a unique identification code for identifying the personal flotation device transceiver;
a timestamp; and
a status code;
wherein if the wireless communication connection between said personal flotation device transceiver system and said boat base station system is interrupted; said secondary algorithm is automatically transmitted by said personal flotation device transceiver system to said boat base station system, and said tertiary algorithm is automatically transmitted by said boat base station system to said network control center system.

2. The personal flotation device communication apparatus of claim 1 further comprising a communication means for connecting a third party to said network control center system.

3. The personal flotation device communication apparatus of claim 1 further comprising a notification/communication signal transmitted by said network control center system to the third party for notifying the third party that an emergency situation has occurred involving said personal flotation device transceiver system and said boat base station system.

4. The personal flotation device communication apparatus of claim 1 wherein the unique identification code for identifying the boat comprises a hull number of the boat on which said boat base station system is installed.

5. The personal flotation device communication apparatus of claim 1 wherein the location of the personal flotation device transceiver comprises a longitude and latitude of said personal flotation device transceiver system.

6. The personal flotation device communication apparatus of claim 1 wherein said boat base station system utilizes a video display as a user interface.

7. The personal flotation device communication apparatus of claim 1 wherein said network control center system utilizes a video display as a user interface.

8. The personal flotation device communication apparatus of claim 1 wherein said boat base station system utilizes audio signals as a user interface.

9. The personal flotation device communication apparatus of claim 1 wherein said network control center system utilizes audio signals as a user interface.

10. The personal flotation device communication apparatus of claim 1 further comprising a metering means for charging a user account.

11. The personal flotation device communication apparatus of claim 1 wherein said personal flotation device transceiver system utilizes audio signals as a user interface.

12. The personal flotation device communication apparatus of claim 1 wherein said communication means for connecting said personal flotation device transceiver system to said boat base station system comprises a wireless Internet connection.

13. The personal flotation device communication apparatus of claim 1 wherein said communication means for connecting said boat base station system to said network control center system comprises a wireless Internet connection.

14. The personal flotation device communication apparatus of claim 12 wherein said Internet connection is a wireless Mobile Virtual Network.

15. The personal flotation device communication apparatus of claim 13 wherein said Internet connection is a wireless Mobile Virtual Network

16. The personal flotation device communication apparatus of claim 1 wherein the location of the boat on which said boat base station system is installed comprises a longitude and latitude of the boat on which said boat base station system is installed.
